(19) United States
(12) Patent Application Publication
(10) Pub. No.: US 2003/0070603 A1
(43) Pub. Date: Apr. 17, 2003

(54) Side stop arm for school bus

(76) Inventors: Gary L. VanderMolen, Fort Wayne, IN (US); Randall A. Hountz, Fort Wayne, IL (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(21) Appl. No.: 09/975,141

(22) Filed: Oct. 11, 2001

(51) Int. Cl. B60R 21/34

(52) U.S. Cl. 116/28 R; 293/117

(57) ABSTRACT

A side stop arm for school buses in various embodiments, each embodiment having the common element of an extendable arm on the side of a bus that contains the STOP sign or moves in concert with the arm. The extendable arm acts as both a deterrent to vehicles that may wish to pass the bus on the driver's side but more importantly acts as warning as to the bus being stopped for loading or discharge of passengers. The first extendable arm is a separate element engaged to the side of the bus. In this embodiment, the extendable arm has a breakaway portion in the event a passing vehicle comes into contact with the arm. In a second embodiment of the invention, the STOP sign is engaged to the end of the extendable arm and it extends outwards with the arm to a position displaced from the side of the bus. In a third embodiment, that is a combination of the first two, the STOP sign is engaged to the end of a first extendable arm that moves in conjunction with a second extendable arm. The second extendable arm is longer than the first and may contain a strobe light or other warning device at an end opposite the side of the bus.

### BACKGROUND

This invention relates to a side stop arm for school buses to work in conjunction with the extension of a STOP sign from the driver's side of a bus. The school bus stop arm with the STOP sign is an auxiliary device used to signal other vehicles that a school bus has stopped to load or discharge passengers. This invention is designed to assist other vehicle drivers in becoming aware that the school bus has stopped to load or discharge passengers. The invention works in conjunction with the STOP sign.

### PRIOR ART

The prior art STOP signs on the sides of school buses were directly mounted to the sides of the school buses. An example is shown in FIG. 1. The STOP sign 111 is rotatably engaged to the side 107 of the body 102 of the bus 101. In the version shown in FIG. 1, the sign 111 is engaged through a hinged connection 112 that allows the sign 111 to be folded against the body 102 of the bus 101 when the bus 101 is not stopped for passenger egress through a door 105. The basic requirements are defined in Society of Automotive Engineers (SAE) J1133. The problem that occurs with these STOP signs on the sides of the buses is that many drivers ignore or do not see them. What is needed is a device or mechanism to work in conjunctions with the STOP sign 111 to heighten the awareness of other drivers of the bus drivers intention to stop to load or discharge passengers.

### SUMMARY

An object of the invention is to provide a side stop arm for school buses that works in conjunction with the J1133 STOP sign to heighten the awareness of other drivers of the bus drivers intention to stop to load or discharge passengers.

The side stop arm for school buses of this invention satisfies the named objective. Each embodiment of the invention has the common element of an extendable arm on the side of the bus that contains the STOP sign or moves in concert with the arm. The extendable arm acts as both a deterrent to vehicles that may wish to pass the bus on the driver's side but more importantly acts as warning as to the bus being stopped for loading or discharge of passengers. In one embodiment, the extendable arm is a separate element engaged to the side of the bus. In this embodiment, the extendable arm has a breakaway portion in the event a passing vehicle comes into contact with the arm. In a second embodiment of the invention, the STOP sign is engaged to the end of the extendable arm and it extends outwards with the arm to a position displaced from the side of the bus. In a third embodiment, that is a combination of the first two, the STOP sign is engaged to the end of a first extendable arm that moves in conjunction with a second extendable arm. The second extendable arm is longer than the first and may contain a strobe light or other warning device at an end opposite the side of the bus. The strobe light or other warning device acts as a warning to drivers to not pass the stopped bus. The fourth embodiment is similar to the second embodiment in that the STOP sign is engaged to an extendable arm. The fourth embodiment extendable arm extends beyond the STOP sign to provide a further deterrent to other vehicles not to pass the bus during passenger egress. Additional effects, features and advantages will be apparent in the written description that follows.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a front view of a prior side STOP sign on a school bus, shown with the sign extended;

FIG. 2 is a first embodiment of a side stop arm installed on a school bus made in accordance with this invention;

FIG. 3 is a second embodiment of a side stop arm installed on a school bus made in accordance with this invention;

FIG. 4 is a third embodiment of a side stop arm installed on a school bus made in accordance with this invention;

FIG. 5 is a fourth embodiment of a side stop arm installed on a school bus made in accordance with this invention; and

FIG. 6 is a perspective view of the school bus of FIG. 2.

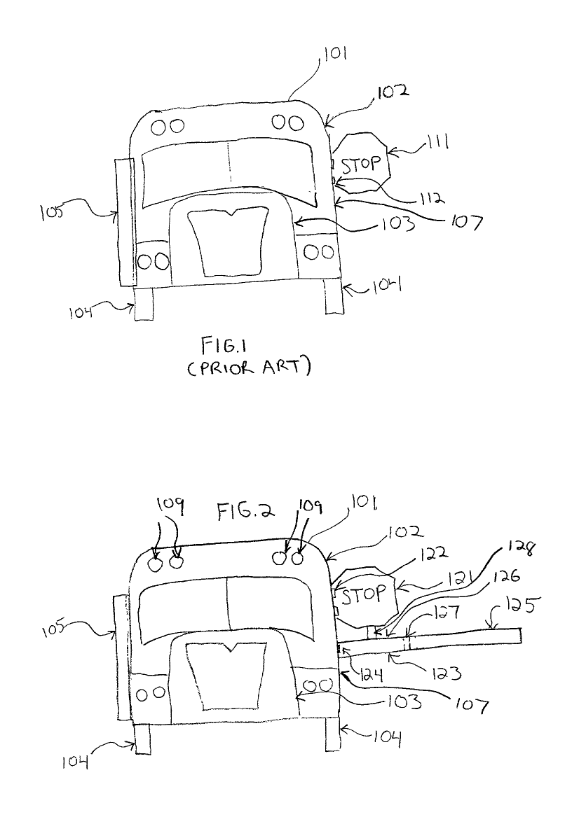

### DETAILED DESCRIPTION OF THE INVENTION

The different embodiments of the side stop arms of this invention may be incorporated into on a bus 101. See FIGS. 2 to 6. The bus 101 will have a chassis 103. The chassis 103 will have axles with wheels 104 engaged. The chassis 103 contains an engine and a drive train to propel the vehicle on the wheels 104. There is a bus body 102 for a driver and passengers engaged to the chassis 102. The body 102 will have a door 105 for passenger loading and discharge, to be referred to here as entry egress. The bus body 102 will have a driver side 107 where the embodiments of this invention are mounted.

Each embodiment of the invention has the common element of an extendable arm on the side of the bus that contains the STOP sign or moves in concert with the arm. The extendable arm acts as a both a deterrent to vehicles that may wish to pass the bus on the driver's side but more importantly acts as warning as to the bus being stopped for loading or discharge of passengers.

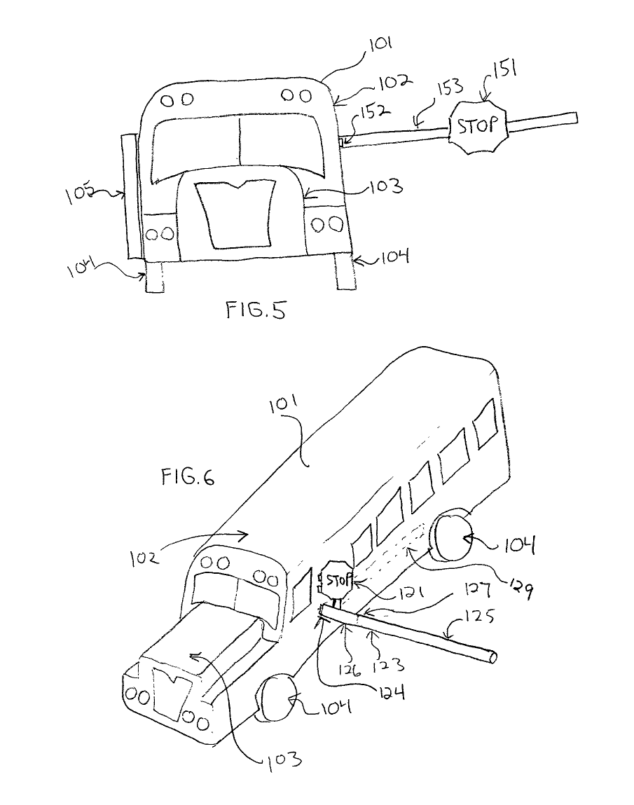

In the first embodiment shown in FIGS. 2 and 6, there is an extendable arm 123 that is a separate element engaged to the side 107 of the bus 101. Note that the perspective view of the bus 101 shown in FIG. 6 is similar to that for all the embodiments. In this first embodiment, the extendable arm 123 is comprised has a breakaway portion 125 in the event a passing vehicle comes into contact with the arm 123. The breakaway away portion 125 is engaged to a bus side remainder portion 126 of the extendable arm 123 through a breakaway mechanism 127. The breakaway mechanism 127 may be a hinged connection that allows separate rotation of the breakaway portion 125 or the breakaway mechanism may be 127 a designed disengagement mechanism that allows the breakaway portion to actually separate from the remainder portion 126 of the extendable arm 123. The disengagement mechanism may be a designed weak spot in the extendable arm 123 materials at the intersection with the breakaway portion 125 to allow for preferential breaking at the beginning of the breakaway portion 125. The designed weak spot may be thinner or weaker materials or perforations or design flaws to ensure proper breakaway. The extendable arm 123 is rotatably engaged to the side 107 of the bus 101 through a rotation mechanism 124. The extendable arm 123 may contain a strobe light to further warn other drivers of the buses intention to stop for entry egress. The strobe light may be activatable upon extension of the extendable arm 123. The STOP sign 121 is a separate element that is rotatably engaged to the side 107 of the bus 101 through a rotation mechanism 112. The STOP sign 121 may be joined through a connecting strut 128 to the extendable arm 123 to ensure movement in concert between the elements. The extendable arm 123 is also rotatably engaged to the bus side 107 for extension. FIG. 6 shows the extendable arm 123 in a stowed position 129 against the bus side 107. Although, extendible arm folding against the bus 101 is the methodology of storage shown, it is envisioned that the arms may be telescopically stored and extended.

The extendible arm 123 may be extended manually independent of door 105 operations, or the extendible arm may be interlocked with the door 105 or door controllers or operators to automatically deploy along with the door 105 as well as with legally required bus flashers 109.

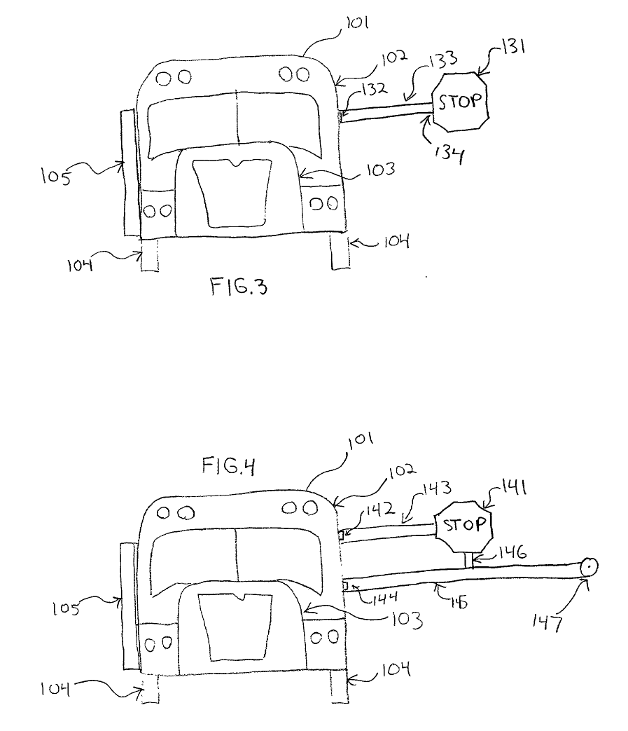

In the second embodiment of the invention shown in FIG. 3, there is a STOP sign 131 engaged to the end 134 of an extendable arm 133. The STOP sign 131 extends outwards with the arm 133 to a position displaced from the side 107 of the bus 101. The extendable arm 133 is rotatably engaged to the side 107 of the bus 101 through a rotation mechanism 132. Telescoping extension is also an option for this embodiment as is a breakaway mechanism for the extendable arm 133. Operation is similar as the first embodiment.

The third embodiment of the invention shown in FIG. 4 is a combination of the first two. There is a STOP sign 141 engaged to the end of a first extendable arm 143 that moves in conjunction with a second extendable arm 145. The first extendable arm 143 is rotatably connected to the bus side 107 through a rotation mechanism 142. The second extendable arm is rotatably connected to the bus side 107 through a second rotation mechanism 144. Telescoping extension is an option as is a breakaway mechanism for the extendable arms. The second extendable arm 145 is longer than the first arm 143 and may contain a strobe light 147 or other warning device at an end opposite the side 107 of the bus body 102. The strobe light 147 or other warning device acts as a warning to drivers to not pass the stopped bus 101 during passenger entry egress. The first extendable arm 143 may be affixed to the second extendable arm 145 through a strut 146 although in concert movement may be otherwise coordinated. Operation is similar as the first embodiment. The strobe light 147 of this embodiment may be used on the extendable arms of the other embodiments.

The fourth embodiment of the invention, shown in FIG. 5, is similar to the second embodiment in that a STOP sign 151 is engaged to an extendable arm 153. The fourth embodiment extendable arm extends beyond the STOP sign 151 to provide a further deterrent to other vehicles not to pass the bus 101 during passenger entry egress. The extendable arm 153 is rotatably engaged to the bus side 107 through a rotation mechanism 152. The rotation mechanisms may be hinges but other connectors allowing rotation are acceptable. A breakaway option similar to the one shown in FIGS. 2 and 6 are an option for the extendable arm 153 of this embodiment.

As described above, the embodiments of the side stop arm of this invention and the bus 101 with the arms installed provide a number of advantages, some of which have been described above and others of which are inherent in the invention. Also modifications may be proposed to the embodiments of the side stop arm and the bus 101 with the arms installed without departing from the teachings herein.

We claim:

1. A passenger bus, comprising:
a chassis with axles with wheels engaged;
a bus body for a driver and passengers engaged to said chassis;
said body having a door for passenger entry and egress;
an extendable arm rotatably engaged to a driver side of said bus;
said extendable arm comprised of a breakaway portion engaged to a bus side remainder portion through a breakaway mechanism;
a STOP sign rotatably engaged to said driver side of said bus; and
said extendable arm and said STOP sign movable in concert.

2. The passenger bus of claim 1, wherein:
said extendable arm is joined to said STOP sign through a connecting strut.

3. The passenger bus of claim 2, wherein:
said breakaway mechanism is a hinged connection allowing separate rotation of said breakaway portion.

4. The passenger bus of claim 2, wherein:
said breakaway portion is a disengagement mechanism allowing said breakaway portion to separate from said remainder portion of said extendable arm.

5. The passenger bus of claim 4, wherein:
said disengagement mechanism is a designed weak spot in said extendable arm materials at an intersection with said breakaway portion and said remainder portion to allow for preferential breaking at a beginning of said breakaway portion.

6. The passenger bus of claim 5, wherein:
said designed weak spot is thinner than other areas of said extendable arm.

7. The passenger bus of claim 5, wherein:
said designed weak spot is made of weaker materials than other areas of said extendable arm.

8. The passenger bus of claim 5, wherein:
said designed weak spot has perforations to allow breakaway of said breakaway portion.

9. The passenger bus of claim 2, wherein:
said extendable arm contains a strobe light activatable on arm extension.

10. A side stop arm in combination with a extendable STOP sign for installation on a passenger bus, the bus having a chassis with axles with wheels engaged, a bus body for a driver and passengers engaged to the chassis, the body having a door for passenger entry and egress, and the body having a driver side, comprising:
an extendable arm rotatably engageable to the driver side of the bus;
said extendable arm comprised of a breakaway portion engaged to a bus side remainder portion through a breakaway mechanism;
a STOP sign rotatably engaged to said driver side of said bus;
said breakaway portion extending out beyond said STOP sign; and
said extendable arm is joined to said STOP sign through a connecting strut.

11. The side stop arm combination of claim 10, wherein:
said breakaway mechanism is a hinged connection allowing separate rotation of said breakaway portion.

12. The side stop arm combination of claim 10, wherein:
said breakaway portion is a disengagement mechanism allowing said breakaway portion to separate from said remainder portion of said extendable arm.

13. The side stop arm combination of claim 12, wherein:
said disengagement mechanism is a designed weak spot in said extendable arm materials at an intersection with said breakaway portion and said remainder portion to allow for preferential breaking at a beginning of said breakaway portion.

14. The side stop arm combination of claim 13, wherein:
said designed weak spot is thinner than other areas of said extendable arm.

15. The side stop arm combination of claim 13, wherein:
said designed weak spot is made of weaker materials than other areas of said extendable arm.

16. The side stop arm combination of claim 13, wherein:
said designed weak spot has perforations to allow breakaway of said breakaway portion.

17. The side stop arm combination of claim 10, wherein:
said extendable arm contains a strobe light activatable on arm extension.

18. A passenger bus, comprising:
a chassis with axles with wheels engaged;
a bus body for a driver and passengers engaged to said chassis;
said body having a door for passenger entry and egress;
a STOP sign engaged to an end of an extendable arm; and
said STOP sign extends outwards to a position displaced from a side of said bus body.

19. The passenger bus of claim 18, wherein:
extendable arm is rotatably engaged to said side of the bus body.

20. The passenger bus of claim 18, wherein:
said extendable arm moves telescopically to extend and retract said STOP sign.

21. The passenger bus of claim 19, wherein:
said extendable arm has a breakaway device to allow a breakaway portion to move out of line with a remainder portion of said extendable arm.

22. The passenger bus of claim 21, wherein:
said extendable arm has a strobe light activatable on arm extension.

23. A passenger bus, comprising:
a chassis with axles with wheels engaged;
a bus body for a driver and passengers engaged to said chassis;
said body having a door for passenger entry and egress;
a STOP sign engaged to an end of a first extendable arm;
said first extendable arm rotatably engaged to a driver side of said bus through a rotation mechanism;
a second extendable arm rotatably engaged to said driver side of said bus through a second rotation mechanism; and
said second extendable arm is longer than said first extendable arm through a strut.

24. The passenger bus of claim 23, wherein:
said second extendable arm contains a warning light to warn other drivers not to pass said bus during passenger entry and egress.

25. A side stop arm in combination with a extendable STOP sign for installation on a passenger bus, the bus having a chassis with axles with wheels engaged, a bus body for a driver and passengers engaged to the chassis, the body having a door for passenger entry and egress, and the body having a driver side, comprising:
a STOP sign engaged to an end of a first extendable arm;
said first extendable arm rotatably engageable to a driver side of the bus through a rotation mechanism;
a second extendable arm rotatably engageable to the driver side of the bus through a second rotation mechanism; and
said second extendable arm is longer than said first extendable arm through a strut.

26. The side stop arm combination of claim 25, wherein:
said second extendable arm contains a warning light to warn other drivers not to pass said bus during passenger entry and egress.

27. A passenger bus, comprising:
a chassis with axles with wheels engaged;
a bus body for a driver and passengers engaged to said chassis;
said body having a door for passenger entry and egress;
a STOP sign engaged to an end of an extendable arm;
said STOP sign extends outwards to a position displaced from a side of said bus body; and
said extendable arm extends beyond said STOP sign.

28. The passenger bus of claim 27, wherein:
extendable arm is rotatably engaged to said side of the bus body.

29. The passenger bus of claim 27, wherein:
said extendable arm moves telescopically to extend and retract said STOP sign.

30. The passenger bus of claim 28, wherein:
said extendable arm has a breakaway device to allow a breakaway portion to move out of line with a remainder portion of said extendable arm.

31. The passenger bus of claim 30, wherein:
said extendable arm has a strobe light activatable on arm extension.

32. The passenger bus of claim 29, wherein:
said extendable arm has a strobe light activatable on arm extension.
